(19) United States
(12) Patent Application Publication
(10) Pub. No.: US 2012/0312427 A1
(43) Pub. Date: Dec. 13, 2012

(54) HIGH-STRENGTH ALUMINUM ALLOY PRODUCT AND METHOD OF PRODUCING THE SAME

(75) Inventors: Shingo IWAMURA, Nagoya-Shi (JP); Tadashi Minoda, Nagoya-Shi (JP); Katsuya Kato, Nagoya-Shi (JP)

(73) Assignee: Sumitomo Light Metal Industries, Ltd.

(21) Appl. No.: 13/471,938

(22) Filed: May 15, 2012

Related U.S. Application Data
(62) Division of application No. 12/312,704, filed on May 21, 2009, now abandoned.

(30) Foreign Application Priority Data
Dec. 13, 2006 (JP) 2006-335310
Jan. 12, 2007 (JP) 2007-004280

(51) Int. Cl. C22C 21/16; B23P 17/00; C22C 21/08; C22C 21/14; C22C 21/02

(52) U.S. Cl. 148/417; 420/534; 420/535; 72/256

(57) ABSTRACT

A high-strength Al—Cu—Mg—Si aluminum alloy product obtained by extrusion is characterized in that the microstructure of the entire surface of the cross-section of the aluminum alloy product is formed of recrystallized grains, the grains have an average aspect ratio (L/t) of 5.0 or less and the orientation density of the grains in the microstructure, for which the normal direction to the {001} plane is parallel to the extrusion direction in comparison with the grains orientated to random orientations, is 50 or less. The high-strength Al—Cu—Mg—Si aluminum alloy product is characterized in that rod-shaped precipitates are arranged in the grains of the matrix in the <100> direction, the precipitates have an average length of 10 to 70 nm and a maximum length of 120 nm or less, and the number density of the precipitates in the [001] direction measured from the (001) plane is 500 or more per square micrometer.

### CROSS REFERENCE TO RELATED APPLICATIONS

This is a divisional of prior U.S. application Ser. No. 12/312,704, filed May 21, 2009, which was the National Stage of International Application No. PCT/JP2007/074358, filed Dec. 12, 2007.

### TECHNICAL FIELD

The present invention relates to a heat-treated high-strength Al—Cu—Mg—Si aluminum alloy product and a method of producing the same.

### BACKGROUND ART

In recent years, it has become important to reduce the fuel consumption of a transport machine by reducing the weight from the viewpoint of global environmental protection. Therefore, an aluminum alloy extruded product has been widely used as a transport structural material due to a high specific strength, a high degree of freedom of the cross-sectional shape, and the like, and a demand for such an aluminum alloy extruded product has increased. In particular, a high-strength aluminum alloy extruded product formed of a heat-treated 7000 series (Al—Zn—Mg—Cu) aluminum alloy, 2000 series (Al—Cu—Mg) aluminum alloy, or the like has been utilized.

However, since the Al—Zn—Mg—Cu alloy and the Al—Cu—Mg alloy exhibit insufficient extrudability, their cost increases due to a low productivity. When extruding a hollow product using such an alloy, the extrusion method is limited to mandrel extrusion (i.e., porthole extrusion cannot be used) due to a high deformation resistance.

A heat-treated aluminum alloy extruded product exhibits a high strength. However, a variation in strength tends to occur depending on the extruded shape, even if the heat treatment is performed under optimum conditions (J. Japan Inst. Metals, vol. 50 (1986), pp. 1016 to 1022). The strength of the above-mentioned 7000 or 2000 series aluminum alloy has been generally improved by forming a fiber structure. In this case, a local recrystallized structure is formed when producing an extruded product having an irregular shape so that a variation in strength occurs to a large extent.

### DISCLOSURE OF THE INVENTION

As an aluminum alloy that solves the above-mentioned problems, a 2013 (Al—Cu—Mg—Si) alloy that exhibits a strength equal to that of a 2024 (Al—Cu—Mg) alloy and exhibits excellent extrudability has been proposed. The inventors of the present invention tested and studied in order to further improve the strength of the 2013 alloy (see the summary of the 110th conference of the Japan Institute of Light Metals, Apr. 13, 2006, pp. 219 to 220). The inventors got an idea from the tests and the studies that the strength of an Al—Mg—Si alloy can be improved by adding Cu, and found that a high-strength alloy can be obtained by optimally controlling the precipitate structure of the Al—Cu—Mg—Si alloy.

The present invention was conceived based on the above findings. An object of the present invention is to provide a heat-treated high-strength Al—Cu—Mg—Si aluminum alloy product that exhibits an excellent extrudability and high strength, and a method of producing the same.

A first embodiment of the present invention relates to a high-strength Al—Cu—Mg—Si aluminum alloy product obtained by extrusion, and a second embodiment of the present invention relates to a high-strength Al—Cu—Mg—Si aluminum alloy product (particularly a hollow high-strength Al—Cu—Mg—Si aluminum alloy product) obtained by extrusion and cold working.

The high-strength aluminum alloy product according to the first embodiment and the method of producing the same are as follows.

(1) A high-strength Al—Cu—Mg—Si aluminum alloy product obtained by extrusion, the microstructure of the entire cross-section of the aluminum alloy product being formed of recrystallized grains, the grains having an average aspect ratio (L/t) of 5.0 or less (wherein L is the average size of the grains in the extrusion direction, and t is the average thickness of the grains), and the orientation density of the grains in the microstructure, for which the normal direction to the {001} plane is parallel to the extrusion direction in comparison with the grains orientated to random orientations, is 50 or less.

(2) The aluminum alloy product according to (1), comprising 0.6 to 3.0% (mass %, hereinafter the same) of Cu, 0.4 to 1.6% of Mg, and 0.2 to 1.4% of Si, with the balance being Al and unavoidable impurities.

(3) The aluminum alloy product according to (2), further comprising at least one of 0.50% or less (excluding 0%, hereinafter the same) of Mn, 0.40% or less of Cr, 0.20% or less of Zr, and 0.20% or less of V.

(4) The aluminum alloy product according to (2) or (3), further comprising at least one of 0.15% or less of Ti and 50 ppm or less of B.

(5) The aluminum alloy product according to any one of (1) to (4), wherein the ratio (D/T) of the diameter D of a billet of the aluminum alloy product before extrusion to the minimum thickness T of the cross-section of the extruded product is 200 or less.

(6) The aluminum alloy product according to any one of (1) to (5), the aluminum alloy product being obtained by extrusion at an extrusion ratio of 20 or more.

The high-strength aluminum alloy product according to the second embodiment and the method of producing the same are as follows.

(7) A high-strength Al—Cu—Mg—Si aluminum alloy product obtained by extrusion and cold working, rod-shaped precipitates being arranged in the grains of the matrix in the <100> direction, the precipitates having an average length of 10 to 70 nm and a maximum length of 120 nm or less, and the number density of the precipitates in the [001] direction measured from the (001) plane being 500 or more per square micrometer.

(8) The aluminum alloy product according to (7), comprising 1.0 to 3.0% of Cu, 0.4 to 1.8% of Mg, and 0.2 to 1.6% of Si, with the balance being Al and unavoidable impurities.

(9) The aluminum alloy product according to (8), further comprising at least one of 0.30% or less (excluding 0%, hereinafter the same) of Mn, 0.40% or less of Cr, 0.25% or less of Zr, and 0.10% or less of V.

(10) The aluminum alloy product according to (8) or (9), further comprising at least one of 0.15% or less of Ti and 50 ppm or less of B.

(11) The aluminum alloy product according to any one of (7) to (10), wherein the matrix has a structure formed of equiaxial recrystallized grains, and has an average aspect ratio (L/ST) of the average size L of the grains in the extrusion direction to the average size ST of the grains in the thickness direction of 1.5 to 4.0.

(12) The aluminum alloy product according to any one of (7) to (11), the aluminum alloy product having an ultimate tensile strength of 450 MPa or more, a proof stress of 400 MPa or more, and an elongation of 7% or more.

(13) A method of producing the aluminum alloy product according to any one of (7) to (12), the method comprising hot-extruding an aluminum alloy having a composition according to any one of (8) to (10) in a hollow shape to obtain a hollow extruded product, subjecting the hollow extruded product to a solution heat treatment and quenching, cold-working the hollow extruded product so that the cross-sectional area and the external profile of the hollow extruded product are reduced, and aging the resulting product.

(14) The method according to (13), wherein the hollow extruded product is cold-worked by drawing the hollow extruded product at a rate of reduction in cross-sectional area of 10 to 50% and a rate of reduction in outer diameter of 7 to 35%.

(15) The method according to (13) or (14), further comprising press-quenching the hollow extruded product after the hot extrusion.

### BEST MODE FOR CARRYING OUT THE INVENTION

The significance of each alloy component of the aluminum alloy product according to the first embodiment, the reasons for limitations to the content of each alloy component, the structural characteristics of the aluminum alloy product, and the method of producing the aluminum alloy product are described below.

Cu is an element necessary to improve the strength of the aluminum alloy product. The Cu content is preferably 0.6 to 3.0%. If the Cu content is less than 0.6%, the strength of the aluminum alloy product may be insufficient. If the Cu content is more than 3.0%, the aluminum alloy product may exhibit a low extrudability due to an increase in hot deformation resistance. The Cu content is more preferably 1.0 to 2.5%, and most preferably 1.5 to 2.0%.

Mg is an element necessary to improve the strength of the aluminum alloy product. The Mg content is preferably 0.4 to 1.6%. If the Mg content is less than 0.4%, the strength of the aluminum alloy product may be insufficient. If the Mg content is more than 1.6%, the aluminum alloy product may exhibit a low extrudability due to an increase in hot deformation resistance. The Mg content is more preferably 0.6 to 1.4%, and most preferably 0.8 to 1.2%.

Si is an element necessary to improve the strength of the aluminum alloy product. The Si content is preferably 0.2 to 1.4%. If the Si content is less than 0.2%, the strength of the aluminum alloy product may be insufficient. If the Si content is more than 1.4%, the aluminum alloy product may exhibit a low extrudability due to an increase in hot deformation resistance. The Si content is more preferably 0.4 to 1.2%, and most preferably 0.6 to 1.0%.

Mn, Cr, Zr, and V are elements selectively added to the aluminum alloy product, and refine the grains. The grain refinement effect can be obtained by adding at least one of Mn, Cr, Zr, and V. The Mn content is preferably 0.50% or less, the Cr content is preferably 0.40% or less, the Zr content is preferably 0.20% or less, and the V content is preferably 0.20% or less. If the content of at least one of Mn, Cr, Zr, and V is more than the upper limit, recrystallization during extrusion may be suppressed so that the desired recrystallized structure may not be obtained, or the aluminum alloy product may exhibit a low extrudability due to an increase in hot deformation resistance. Moreover, giant compounds may be formed so that the ductility and the toughness of the aluminum alloy product may decrease. The Mn content is more preferably 0.40% or less, and most preferably 0.30% or less. The Cr content is more preferably 0.30% or less, and most preferably 0.25% or less. The Zr content is more preferably 0.15% or less, and most preferably 0.10% or less. The V content is more preferably 0.15% or less, and most preferably 0.10% or less.

Ti and B are elements selectively added to the aluminum alloy product. Ti and B refine the cast structure to improve the extrudability of the aluminum alloy product. The Ti content is preferably 0.15% or less, and the B content is preferably 50 ppm or less. If the content of at least one of Ti and B is more than the upper limit, giant compounds may be formed so that the ductility and the toughness of the aluminum alloy product may decrease.

The aluminum alloy product contains Fe and Zn as unavoidable impurities. Fe is mainly mixed from a raw material or a recycled metal. If the Fe content is more than 0.5%, the ductility and the toughness of the aluminum alloy product may decrease. Therefore, it is preferable to limit the Fe content to 0.5% or less. Zn is mainly mixed from a recycled metal. If the Zn content is more than 0.3%, the corrosion resistance of the aluminum alloy product may decrease. Therefore, it is preferable to limit the Zn content to 0.3% or less.

The aluminum alloy product according to the first embodiment is obtained by extrusion. It is preferable that the microstructure of the entire cross-section of the extruded product be formed of recrystallized grains, and the grains have an average aspect ratio (L/t) of 5.0 or less (wherein L is the average size (or average length) of the grains in the extrusion direction, and t is the average thickness of the grains (i.e., the minimum average size of the grains measured in the direction perpendicular to the extrusion direction)). When recrystallization is inhibited during extrusion, the hot deformation resistance of the aluminum alloy product increases to a large extent so that the extrudability of the aluminum alloy product decreases. As a result, it is difficult to extrude a product having a complicated cross-sectional shape. Moreover, the extruded product does not have a recrystallized structure, but has a fiber structure. When the extruded product has a fiber structure, the average aspect ratio of the grains cannot be measured since the grains cannot be determined.

The lower limit of the average aspect ratio of the grains is not specified. However, the average aspect ratio of the grains of the extruded product is normally 1.0 or more. When the microstructure of the extruded product is formed of recrystallized grains, the strength of the extruded product may decrease if the average aspect ratio of the grains exceeds the upper limit. Therefore, the average aspect ratio of the grains is preferably 5.0 or less. The average aspect ratio of the grains is more preferably 3.0 or less.

It is preferable that the orientation density of the grains in the microstructure of the extruded product, for which the normal direction to the {001} plane is parallel to the extrusion direction in comparison with the grains orientated to random orientations, is 50 or less. The orientation density of the grains for which the normal to the {001} plane is parallel to the extrusion direction is measured by exposing the surface of the extruded product perpendicular to the extrusion direction, analyzing the texture by the Schulz X-ray reflection method, and measuring the degree of integration in the <001> orientation in the (100) pole figure.

The grains for which the normal to the {001} plane is parallel to the extrusion direction form a number of slip planes when a tensile load is applied in the extrusion direction so that a multiple slip easily occurs. Therefore, the strength of the extruded product decreases. Therefore, the percentage of the grains for which the normal to the {001} plane is parallel to the extrusion direction must be reduced in order to achieve high strength. The orientation density of the grains for which the normal to the {001} plane is parallel to the extrusion direction in comparison with the grains orientated to random directions is preferably 50 or less. If the orientation density is more than 50, a sufficient strength may not be achieved. The orientation density is more preferably 35 or less, and most preferably 20 or less.

The production conditions for the aluminum alloy product according to the first embodiment are described below. An ingot of an aluminum alloy containing Cu, Mg, and Si as the main alloy components (preferably an aluminum alloy having the above-described composition) is cast using a DC casting method, and homogenized. When using an aluminum alloy having the composition according to any one of (2) to (4), the ingot is preferably homogenized at 500 to 550° C. for two hours or more.

If the homogenization temperature or the homogenization time is less than the lower limit, diffusion of the elements segregated during casting may become insufficient. As a result, a decrease in strength or a decrease in ductility or toughness may occur. If the homogenization temperature is higher than the upper limit, the ingot may melt. The homogenization time is preferably set within a practical range although the upper limit is not specified. The cooling rate after homogenization is not 20 particularly limited. The ingot may be slowly cooled in a furnace, or may be subjected to forced air cooling using a fan, or may be cooled with water.

The homogenized ingot may be cooled to room temperature, and again heated before extrusion. Alternatively, the homogenized ingot may be directly cooled to the extrusion temperature from the homogenization temperature. The ingot thus heated is hot-extruded. The extrusion ratio (cross-sectional area before extrusion/cross-sectional area after extrusion) is preferably 20 or more. If the extrusion ratio is less than 20, a decrease in strength or a decrease in ductility or toughness may occur. Moreover, an abnormal grain growth may occur during a solution heat treatment described later so that the average aspect ratio of the grains may exceed 5.0. The extrusion ratio is more preferably 30 or more, and most preferably 40 or more.

The ratio (D/T) of the diameter D of the billet before extrusion to the minimum 5 thickness T of the cross-section of the extruded product is preferably 200 or less. If the ratio (D/T) exceeds 200, the orientation density of the grains in the microstructure of the extruded product, for which the normal direction to the {001} plane is parallel to the extrusion direction in comparison with the grains orientated to random orientations, is 50 or less so that a decrease in strength may occur. The ratio (D/T) of the diameter D of the billet before extrusion to the minimum thickness T of the cross-section of the extruded product is more preferably 130 or less, and most preferably 70 or less.

When the extruded product is a round rod, the minimum thickness T refers to the diameter of the round rod. When the extruded product is a square rod, the minimum thickness T refers to the length of the short side of the square rod. When the extruded product has an oval shape, the minimum thickness T refers to the minor axis of the product.

The extruded product is then subjected to a solution heat treatment. When the aluminum alloy extruded product has the composition according to any one of (2) to (4), the extruded product is preferably subjected to the solution heat treatment at 450 to 550° C. for 10 minutes or more. If the solution heat treatment temperature or the solution heat treatment time is less than the lower limit, a decrease in strength may occur. If the solution treatment temperature is higher than the upper limit, the extruded product may melt. The solution treatment time is preferably set within a practical range although the upper limit is not specified.

The extruded product that has been subjected to the solution heat treatment is then quenched. As a quenchant, tap water at 50° C. or less or a polyalkylene glycol aqueous solution at 50° C. or less may be used. The solution heat treatment and quenching may be replaced by extruding the ingot at 450° C. or more and water-cooling the extruded product immediately after extrusion (i.e., press quenching).

The quenched extruded product is subjected to artificial aging. When the aluminum alloy extruded product has the composition according to any one of (2) to (4), the extruded product is preferably subjected to artificial aging at 170 to 200° C. for 4 to 12 hours. The optimum combination of the artificial aging temperature and the artificial aging time varies depending on the alloy composition. If at least one of the artificial aging temperature and the artificial aging time is less than the lower limit or more than the upper limit, it may be difficult to achieve a sufficient strength.

The significance of each alloy component of the aluminum alloy product according to the second embodiment, the reasons for limitations to the content of each alloy component, the structural characteristics of the aluminum alloy product, and the method of producing the aluminum alloy product are described below.

Cu is a basic alloy element of the Al—Cu—Mg—Si alloy according to the present invention. Cu improves the strength of the alloy together with Al or Mg and Si. The Cu content is preferably 1.0 to 3.0%. If the Cu content is less than 1.0%, the number density of the precipitates produced during artificial aging may decrease so that a sufficient strength may not be achieved. If the Cu content is more than 3.0%, the solute Cu content during extrusion may increase so that the extrudability may decrease. Moreover, grain boundary precipitates may be produced to a large extent so that the ductility and the like may be adversely affected. The Cu content is more preferably 1.25 to 2.5%, and most preferably 1.5 to 2.0%.

Mg is a basic alloy element of the Al—Cu—Mg—Si alloy according to the present invention. Mg improves the strength of the alloy together with Cu and Si. The Mg content is preferably 0.4 to 1.8%. If the Mg content is less than 0.4%, a sufficient strength may not be achieved. If the Mg content is more than 1.8%, the solute Mg content during extrusion may increase so that the extrudability may decrease. The Mg content is more preferably 0.6 to 1.5%, and most preferably 0.8 to 1.2%.

Si is a basic alloy element of the Al—Cu—Mg—Si alloy according to the present invention. Si improves the strength of the alloy together with Cu and Mg. The Si content is preferably 0.2 to 1.6%. If the Si content is less than 0.2%, a sufficient strength may not be achieved. If the Si content is more than 1.6%, the solute Si content during extrusion may increase so that the extrudability may decrease. Moreover, an Si phase may be precipitated at the crystal grain boundaries so that the ductility and the like may be adversely affected. The Si content is more preferably 0.4 to 1.3%, and most preferably 0.6 to 1.0%.

Mn, Cr, Zr, and V are elements selectively added to the alloy, and are involved in microstructure control. The Mn content is preferably 0.30% or less, the Cr content is preferably 0.40% or less, the Zr content is preferably 0.25% or less, and the V content is preferably 0.10% or less. If the content of any one of Mn, Cr, Zr, or V exceeds the upper limit, the alloy may exhibit low extrudability due to an increase in hot deformation resistance so that clogging or the like may occur. The Mn content is more preferably 0.25% or less, and most preferably 0.20% or less. The Cr content is more preferably 0.35% or less, and most preferably 0.30% or less. The Zr content is more preferably 0.20% or less, and most preferably 0.15% or less. The V content is more preferably 0.07% or less, and most preferably 0.05% or less.

Fe and Zn are contained in the alloy as impurities. Since Fe and Zn decrease the ductility, it is preferable that the content of Fe and Zn be as low as possible. The effects of the present invention are not impaired if the Fe content is 0.40% or less and the Zn content is 0.30% or less.

Ti and B refine the cast structure so that the distribution of constituent particles produced during casting and the grain structure after extrusion are made uniform. The Ti content is preferably 0.15% or less, and the B content is preferably 50 ppm or less. If the content of Ti or B is more than the upper limit, a large intermetallic compound may be produced so that the ductility and the like may be adversely affected.

The size and the number density of precipitates in the grains of the aluminum alloy product according to the second embodiment are limited for the following reasons.

The precipitates in the grains are precipitated in the shape of a rod in the <100> direction during artificial aging, and inhibit the movement of a dislocation in the slip plane to increase the strength of the aluminum alloy product. The precipitates must have an average length of 10 nm or more so that the precipitates contribute to an increase in strength. If the average length of the precipitates exceeds 70 nm, the density of the precipitates decreases so that an increase in strength may be insufficient. It is preferable that the precipitates have a uniform size in order to ensure that the precipitates effectively inhibit the movement of a dislocation. Therefore, the size of the precipitates must be 120 nm or less.

The strength of the aluminum alloy product is affected by the number density of the precipitates. In order to achieve a high strength stably, it is important that the number density of the precipitates in the [001] direction measured from the (001) plane is 500 or more per square micrometer. If the number density of the precipitates in the [001] direction measured from the (001) plane is less than 500 per square micrometer, it may be difficult to achieve a high strength, even if the size of the precipitates satisfies the above-mentioned conditions.

Therefore, it is important in the present invention that the precipitates in the grains in the <100> direction have an average length of 10 to 70 nm and a maximum length of 120 nm or less, and the number density of the precipitates in the [001] direction measured from the (001) plane is 500 or more per square micrometer. It is more preferable that the precipitates in the grains have an average length of 20 to 60 nm and a maximum length of 100 nm or less, and the number density of the precipitates in the [001] direction measured from the (001) plane is 750 or more per square micrometer.

It is preferable that the aluminum alloy product according to the second embodiment (particularly a hollow extruded product used as a material for a cold-worked hollow aluminum alloy product) have a crystallographic structure formed of equiaxial recrystallized grains. A fiber structure (i.e., a grain structure that extends in the extrusion direction) is generally formed to achieve an increase in strength. However, when producing an extruded product having an irregular shape by porthole extrusion or the like, the deformation amount differs depending on the area of the cross-section of the extruded product. Therefore, secondary recrystallization (abnormal grain growth) partially occurs during the solution heat treatment so that the final product has a non-uniform crystallographic structure. As a result, the strength of the extruded product varies to a large extent. In order to provide a cold-worked hollow product having a stable strength, it is preferable that the extruded product have an equiaxial recrystallized grain structure. It is preferable that the cold-worked hollow product having a stable high strength have a grain structure that extends in the working direction to some extent. The average aspect ratio is preferably 1.5 to 4.0. The average aspect ratio refers to the ratio (L/ST) of the average size L of the grains in the extrusion direction to the average size ST of the grains in the thickness direction (i.e., the direction of the thickness of the extruded product).

A method of producing a hollow aluminum alloy product according to the second embodiment is described below. First, an aluminum alloy having the above-mentioned composition is melted according to a conventional method. An ingot of the aluminum alloy is cast using a DC casting method or the like, and subjected to homogenization, hot extrusion, a solution heat treatment, cold working, and artificial aging to obtain a T8 temper material.

It is preferable to homogenize the ingot at 490 to 550° C. for two hours or more. If the homogenization temperature is less than 490° C. or the homogenization time is less than two hours, since the crystallized (or segregated) constituent particles may not be sufficiently dissolved, the solute main elements (Cu, Mg, and Si) content that contributes to an increase in strength may decrease so that it may be difficult to achieve a high strength. If the homogenization temperature is higher than 550° C., the ingot may melt due to eutectic melting. The homogenization temperature is more preferably 510 to 550° C., and most preferably 530 to 550° C. The homogenization time is more preferably four hours or more, and most preferably six hours or more. The upper limit of the homogenization time is not specified. However, the homogenization time is preferably less than 12 hours from the viewpoint of industrial production efficiency.

After homogenization, the ingot is hot-extruded into a desired hollow shape. The Al—Cu—Mg—Si alloy according to the present invention may be also extruded by a porthole extrusion method as well as a mandrel extrusion method. It is preferable that the temperature of the billet when starting extrusion be 450 to 520° C. for both methods. If the temperature of the billet is less than 450° C., recrystallization during extrusion may be insufficient so that a fiber structure non-uniformly remains in the extruded product. As a result, the strength of the extruded product may decrease. Moreover, the extrusion pressure may exceed the capability of the extrusion press due to an increase in deformation resistance so that extrusion may be impossible. If the temperature of the billet exceeds 520° C., the temperature of the extruded product may exceed the eutectic melting temperature due to heat generation during extrusion so that cracks may occur. The extrusion speed of the product is preferably 15 m/min or less. If the extrusion speed exceeds 15 m/min, clogging may occur.

Note that a press quenching method may be used in the present invention. The press quenching method is a method of quenching the extruded products immediately after hot extrusion. The press quenching method combines extrusion and solution heat treatment by utilizing the extrusion temperature. Therefore, it is important to adjust the temperature of the extruded product within the range of the solution heat treatment temperature. This is achieved by adjusting the temperature of the billet when starting extrusion to 450 to 520° C. If the temperature of the billet is less than 450° C., the temperature of the extruded product may not reach within the range of the solution heat treatment temperature. Moreover, extrusion may be impossible due to an increase in the deformation resistance. If the temperature of the billet exceeds 520° C., eutectic melting may occur so that cracks may occur in the extruded product. It is also important to cool the extruded product quickly. The average cooling rate until the temperature of the product removed from the platen reaches about room temperature is preferably 500° C./min or more. If the cooling rate is less than 500° C./min, coarse precipitates of the main elements may form during cooling so that a high strength may not be achieved. The cooling rate is more preferably 1000° C./min or more.

When the billet is extruded by a method other than the press quenching method, the extruded product is subjected to solution heat treatment. The solution heat treatment is performed at 520 to 550° C. for one hour or more. The resulting product is preferably cooled by water quenching at a cooling rate of 500° C./rain or more. If the solution heat treatment temperature is less than 520° C., the solute main elements (Cu, Mg, and Si) content may be insufficient so that a high strength may not be achieved. If the solution heat treatment temperature exceeds 550° C., the mechanical properties of the final product may be impaired due to eutectic melting. The solution heat treatment temperature is more preferably 535 to 550° C. If the cooling rate after the solution heat treatment is less than 500° C./min, coarse precipitates of the main elements may form during cooling so that a high strength may not be achieved. The cooling rate is more preferably 1000° C./min or more. The extruded product may be cold-worked (e.g., drawn) before the solution heat treatment.

The extruded product subjected to the solution heat treatment and quenching is cold-worked in order to improve the strength. For example, the extruded product is subjected to drawing that reduces the cross-sectional area (thickness) and the external profile (outer diameter), rolling, or the like. The rate of reduction in cross-sectional area is preferably 10 to 50%, and the rate of reduction in external profile is preferably 7 to 35%. When producing a pipe-shaped drawn product, the extruded product is preferably subjected to drawing that reduces the cross-sectional area by 10 to 50% and reduces the external profile by 7 to 35%. A dislocation introduced by cold working contributes to an increase in strength due to work hardening, accelerates diffusion of solute atoms during artificial aging described later, and serves as a precipitate nucleation site to refine the precipitate structure. The precipitate structure is thus obtained. If the rate of reduction in cross-sectional area is less than 10% or the rate of reduction in external profile is less than 7%, the above-mentioned effects may not be obtained. If the rate of reduction in cross-sectional area exceeds 50% or the rate of reduction in external profile exceeds 35%, the material may break during drawing so that the final product may not be obtained.

The extruded product is artificially aged after cold working (e.g., drawing). The optimum aging conditions that satisfy the above-mentioned size and number density of the precipitates vary depending on not only aging temperature and aging time but also the cold-working conditions. If the aging temperature is 130° C. or less, precipitation may be insufficient. If the aging temperature is 220° C. or more, the form of the precipitates may change so that an increase in strength may not be achieved. If the aging time is two hours or less, precipitation may be insufficient. If the aging time is 25 hours or more, the precipitates may coarsen so that an increase in strength may not be achieved. The formation rate and the growth rate of the precipitates vary depending on the reduction ratio. Formation and growth of the precipitates are accelerated as the reduction ratio increases. The optimum aging conditions are set so that the aging temperature T (° C.) is more than 130° C. and less than 220° C., the aging time t (h) is more than 2 hours and less than 25 hours, and the aging temperature T (° C.), the aging time t (h), and the reduction ratio ε (%) (equivalent to the rate of reduction in cross-sectional area) satisfy the following relationship.

30<(ε/100)×t×(T−120)<200 (130<T<220, 2<t<25)

The cold-worked hollow Al—Cu—Mg—Si alloy product obtained by the above-described process stably exhibits a high strength (i.e., tensile strength: 450 MPa or more, proof stress: 400 MPa or more) and high ductility (i.e., elongation: 7% or more), and may be suitably used as a transport material. Moreover, since the cold-worked hollow Al—Cu—Mg—Si alloy product exhibits an excellent extrudability, the production cost can be reduced.

### EXAMPLES

The present invention is described below by way of examples and comparison examples to demonstrate the effects of the present invention. Note that the following examples illustrate only one aspect of the present invention. The present invention is not limited to the following examples.

### Example 1

An ingot (diameter: 200 mm) of each of aluminum alloys A to M having compositions shown in Table 1 was cast using a DC casting method. The ingot was homogenized at 540° C. for six hours, and allowed to cool to room temperature.

TABLE 1

| Alloy | Cu | Mg | Si | Mn | Cr | Zr | V | Ti | B | Fe | Zn | Al |
|---|---|---|---|---|---|---|---|---|---|---|---|---|
| A | 1.8 | 0.9 | 0.9 | — | 0.05 | — | — | 0.02 | 13 | 0.2 | — | Balance |
| B | 1.5 | 0.8 | 0.6 | — | 0.06 | — | — | 0.02 | 15 | 0.3 | — | Balance |
| C | 1.1 | 0.6 | 0.5 | — | 0.06 | — | — | 0.03 | 16 | 0.2 | — | Balance |
| D | 1.9 | 1.2 | 1.0 | — | 0.06 | — | — | 0.02 | 14 | 0.2 | 0.2 | Balance |
| E | 2.5 | 1.3 | 1.2 | — | 0.05 | — | — | 0.02 | 14 | 0.2 | — | Balance |
| F | 2.4 | 0.7 | 0.6 | — | 0.07 | — | — | 0.01 | 10 | 0.4 | — | Balance |
| G | 1.2 | 1.3 | 1.2 | — | 0.05 | — | — | 0.02 | 13 | 0.2 | — | Balance |
| H | 1.7 | 1.0 | 0.9 | 0.12 | 0.09 | 0.03 | 0.02 | 0.03 | 18 | 0.1 | — | Balance |
| I | 1.7 | 0.9 | 1.0 | 0.25 | — | — | — | 0.01 | 9 | 0.2 | 0.3 | Balance |
| J | 1.8 | 1.1 | 0.9 | — | 0.22 | — | — | 0.02 | 10 | 0.1 | — | Balance |
| K | 1.8 | 1.0 | 1.0 | — | — | 0.08 | — | 0.03 | 17 | 0.1 | 0.1 | Balance |
| L | 1.7 | 1.0 | 0.7 | — | — | — | 0.09 | 0.01 | 8 | 0.2 | — | Balance |
| M | 1.8 | 1.0 | 0.8 | — | 0.05 | — | — | 0.12 | 38 | 0.1 | — | Balance |

Unit: mass % (excluding B (ppm))

Each ingot was heated to 500° C. using an induction furnace, and hot-extruded in the shape of a tabular sheet having a width of 150 mm and a thickness of 5 mm (extrusion ratio: 42, billet diameter/minimum thickness ratio (D/T): 40). The extrusion speed (outlet-side product speed) was set at 5 m/min. Each extruded product was subjected to a solution heat treatment at 540° C. for one hour, and quenched into tap water at room temperature. Each extruded product was then subjected to artificial aging at 190° C. for eight hours to obtain specimens 1 to 13. The specimens 1 to 13 were subjected to the following tests.

Average aspect ratio of grains: A microstructure observation sample (15×15 mm) was cut from the center of the specimen in the widthwise direction. The sample was fixed in resin so as to the cross-section perpendicular to the widthwise direction became the polishing surface. The sample was polished finally using #1200 emery paper, buff-polished, and then etched at 25° C. for 20 seconds using a No. 3 etchant (2 ml of hydrofluoric acid, 3 ml of hydrochloric acid, 5 ml of nitric acid, and 190 ml of water) described in ASTM E407 to expose the grain structure. The sample was photographed using an optical microscope at a magnification of 50. The average size L of the grains in the extrusion direction (lengthwise direction) was measured by the cutting method in accordance with ASTM E112, and the minimum average size t of the grains measured in the direction perpendicular to the extrusion direction was determined. The average aspect ratio (L/t) of the grains was then calculated.

The orientation density of grains for which the normal to the {001} plane was parallel to the extrusion direction: A sample (width 15 mm, length: 15 mm) was cut from the center of the specimen in the widthwise direction. The polishing surface (i.e., the cross-section perpendicular to the extrusion direction) of the sample was polished finally using #1200 emery paper, and corroded for 10 seconds using a macroetchant prepared by mixing nitric acid, hydrochloric acid, and hydrofluoric acid to prepare an X-ray diffraction sample. The (100) pole figure of each sample was measured by the Schulz X-ray reflection method, and orientation density in the <001> orientation was calculated. Tensile test: A tensile test sample (width 40 mm, length: 250 mm) was cut from the center of the specimen in the widthwise direction, and formed into a JIS No. 5 tensile test sample. The sample was subjected to a tensile test at room temperature in accordance with JIS Z 2241 to measure the ultimate tensile strength, the 0.2% proof stress, and the elongation of the sample. The test results are shown in Table 2.

TABLE 2

| | | | Orientation density of | Tensile properties | | |
|---|---|---|---|---|---|---|
| | | Average aspect | grains for which normal to | Ultimate | | |
| | | ratio of | {001} plane is parallel to | tensile strength | Proof stress | Elongation |
| Specimen | Alloy | grains | extrusion direction | (MPa) | (MPa) | (%) |
| 1 | A | 1.3 | 5 | 419 | 386 | 12 |
| 2 | B | 1.5 | 4 | 370 | 327 | 14 |
| 3 | C | 1.4 | 6 | 325 | 279 | 16 |
| 4 | D | 1.4 | 2 | 464 | 439 | 11 |
| 5 | E | 1.3 | 3 | 514 | 493 | 10 |
| 6 | F | 1.5 | 3 | 391 | 337 | 13 |
| 7 | G | 1.5 | 5 | 469 | 460 | 11 |
| 8 | H | 3.5 | 27 | 408 | 376 | 12 |
| 9 | I | 3.7 | 35 | 403 | 377 | 12 |
| 10 | J | 3.8 | 38 | 401 | 369 | 11 |
| 11 | K | 3.7 | 34 | 404 | 372 | 11 |
| 12 | L | 2.9 | 25 | 408 | 370 | 12 |
| 13 | M | 1.4 | 7 | 420 | 385 | 12 |

As shown in Table 2, the average aspect ratio (L/t) of the grains of the specimens 1 to 13 according to the present invention was 5.0 or less, and the orientation density of the grains for which the normal to the {001} plane was parallel to the extrusion direction in comparison with the grains orientated to random orientations was 50 or less. The specimens 1 to 13 exhibited a high tensile strength, proof stress, and elongation corresponding to the chemical composition.

### Example 2

The ingot (diameter: 200 mm) of the alloy A shown in Table 1 that was cast in Example 1 was homogenized at 540° C. for six hours, and allowed to cool to room temperature. The homogenized ingot was heated to 500° C. using an induction furnace, and hot-extruded into a cross-sectional shape shown in Table 3 to obtain extruded products 14 to 20. The extrusion speed (outlet-side product speed) was set at 5 m/min.

Each extruded product was subjected to a solution heat treatment at 540° C. for one hour, and quenched using tap water at room temperature. Each extruded product was then subjected to artificial aging at 190° C. for eight hours to obtain specimens 14 to 20. The average aspect ratio of the grains of each specimen and the orientation density of the grains for which the normal to the {001} plane was parallel to the extrusion direction were measured under the same conditions as in Example 1. The microstructure observation position for calculating the average aspect ratio of the grains was as follows. Specifically, the microstructure observation position of the specimen 14 was the center of the round rod. The microstructure observation position of the specimen 15 was the center in the thickness direction at the center in the widthwise direction (i.e., the side having a length of 100 mm). The microstructure observation position of the specimen 16 was the center in the thickness direction at the center in the widthwise direction (i.e., the side having a length of 30 mm). The microstructure observation position of the specimen 17 was the center of the oval. The microstructure observation position of the specimen 18 was the center in the thickness direction at the center of the side having a length of 100 mm. The microstructure observation position of the specimen 19 was the center in the thickness direction at an arbitrary position. The microstructure observation position of the specimen 20 was the center in the thickness direction at a position 24 mm from the end of the side having a length of 100 mm. The surface defined by the extrusion direction and the minimum thickness T was the polishing surface. JIS No. 2 tensile test pieces were formed using the specimens 14 and 17. JIS No. 5 samples were formed using the specimens 15 and 16. A JIS No. 5 tensile test piece was formed using the specimen 18 (from the side having a length of 100 mm). A JIS No. 11 sample was formed using the specimen 19. A JIS No. 5 tensile test piece was formed using the specimen 20 (from the side having a length of 100 mm). The samples were subjected to a tensile test at room temperature in accordance with JIS Z 2241 to measure the ultimate tensile strength, the 0.2% proof stress, and the elongation. The test results are shown in Table 4.

TABLE 3

| | | | | | Billet |
|---|---|---|---|---|---|
| | | | | | diam- |
| | | | | | eter/ |
| | | | | | mini- |
| | | | | | mum |
| | | Shape of extruded product | | | thick- |
| | | | Minimum | Extru- | ness |
| Spec- | | | thickness | sion | ratio |
| imen | Alloy | Width (mm) | (mm) | ratio | (D/T) |
| 14 | A | Round rod (diameter: 20 mm) | 20.0 | 100 | 10 |
| 15 | A | Tabular sheet (100 × 5.8 mm) | 5.8 | 54 | 34 |
| 16 | A | Square rod (30 × 15 mm) | 15.0 | 70 | 13 |
| 17 | A | Oval (major axis: 20 mm, | 10.0 | 200 | 20 |
| | | minor axis: 10 mm) | | | |
| 18 | A | Square pipe (external size: | 1.5 | 89 | 133 |
| | | 100 × 20 × 1.5 mm | | | |
| | | (thickness)) | | | |
| 19 | A | Pipe (outer diameter: 20 mm, | 15.0 | 229 | 13 |
| | | inner diameter: 15 mm) | | | |
| 20 | A | T-shaped cross section | 2.0 | 126 | 100 |
| | | (width: 100 mm, height: | | | |
| | | 30 mm, thickness: 2 mm) | | | |

TABLE 4

| | | | Orientation density of grains | Tensile properties | | |
|---|---|---|---|---|---|---|
| | | Average aspect | for which normal to {001} | Ultimate | | |
| | | ratio of | plane is parallel to | tensile strength | Proof stress | Elongation |
| Specimen | Alloy | grains | extrusion direction | (MPa) | (MPa) | (%) |
| 14 | A | 1.5 | 12 | 414 | 381 | 11 |
| 15 | A | 1.4 | 6 | 416 | 387 | 12 |
| 16 | A | 1.4 | 8 | 416 | 383 | 12 |
| 17 | A | 1.8 | 24 | 405 | 371 | 10 |
| 18 | A | 1.5 | 11 | 410 | 384 | 11 |
| 19 | A | 1.9 | 27 | 406 | 374 | 10 |
| 20 | A | 1.4 | 15 | 411 | 385 | 12 |

As shown in Table 4, the average aspect ratio (L/t) of the grains of the specimens 14 to 20 according to the present invention was 5.0 or less, and the orientation density of the grains for which the normal to the {001} plane was parallel to the extrusion direction in comparison with the grains orientated to random orientations was 50 or less. The specimens 14 to 20 exhibited a high tensile strength, proof stress, and elongation.

### Comparative Example 1

An ingot of each of aluminum alloys N to Y having compositions shown in Table 5 was cast using a DC casting method, homogenized, cooled, heated, hot-extruded, and subjected to a solution heat treatment, quenching, and artificial aging under the same conditions as in Example 1 to obtain specimens 21 to 32. The average aspect ratio of the grains of each specimen and the orientation density of the grains for which the normal to the {001} plane was parallel to the extrusion direction were measured under the same conditions as in Example 1. Each specimen was also subjected to a tensile test under the same conditions as in Example 1. The test results are shown in Table 6.

TABLE 5

| Alloy | Cu | Mg | Si | Mn | Cr | Zr | V | Ti | B | Fe | Zn | Al |
|---|---|---|---|---|---|---|---|---|---|---|---|---|
| N | 0.2 | 0.6 | 0.4 | — | 0.07 | — | — | 0.03 | 17 | 0.1 | — | Balance |
| O | 0.8 | 0.2 | 0.5 | — | 0.06 | — | — | 0.02 | 16 | 0.2 | — | Balance |
| P | 0.8 | 0.5 | 0.1 | — | 0.07 | — | — | 0.02 | 14 | 0.2 | — | Balance |
| Q | 3.8 | 1.5 | 1.3 | — | 0.06 | — | — | 0.03 | 18 | 0.3 | — | Balance |
| R | 2.5 | 1.9 | 1.2 | — | 0.06 | — | — | 0.03 | 16 | 0.2 | — | Balance |
| S | 2.6 | 1.6 | 1.7 | — | 0.05 | — | — | 0.01 | 12 | 0.1 | — | Balance |
| T | 1.7 | 0.9 | 0.8 | 0.68 | — | — | — | 0.03 | 16 | 0.2 | — | Balance |
| U | 1.7 | 0.9 | 1.0 | 0.12 | 0.53 | — | — | 0.02 | 15 | 0.3 | — | Balance |
| V | 1.7 | 1.0 | 0.9 | — | — | 0.27 | — | 0.01 | 10 | 0.2 | — | Balance |
| W | 1.8 | 1.1 | 0.9 | — | — | — | 0.28 | 0.03 | 15 | 0.2 | — | Balance |
| X | 1.7 | 1.1 | 0.7 | — | 0.08 | — | — | 0.28 | 73 | 0.3 | 0.2 | Balance |
| Y | 1.6 | 1.0 | 0.9 | — | 0.10 | — | — | 0.01 | 11 | 0.8 | 0.7 | Balance |

Unit: mass % (excluding B (ppm))

TABLE 6

| | | | Orientation density of | Tensile properties | | |
|---|---|---|---|---|---|---|
| | | Average | grains for which normal to | Ultimate | | |
| | | aspect ratio | {001} plane is parallel to | tensile strength | Proof stress | Elongation |
| Specimen | Alloy | of grains | extrusion direction | (MPa) | (MPa) | (%) |
| 21 | N | 1.3 | 8 | 284 | 243 | 18 |
| 22 | O | 1.5 | 6 | 271 | 221 | 19 |
| 23 | P | 1.5 | 10 | 267 | 206 | 19 |
| 24 | Q | — | — | — | — | — |
| 25 | R | — | — | — | — | — |
| 26 | S | — | — | — | — | — |
| 27 | T | Could not be | 4 | 447 | 407 | 8 |
| | | measured | | | | |
| 28 | U | Could not be | 4 | 467 | 436 | 9 |
| | | measured | | | | |
| 29 | V | Could not be | 2 | 469 | 436 | 9 |
| | | measured | | | | |
| 30 | W | Could not be | 6 | 484 | 452 | 8 |
| | | measured | | | | |
| 31 | X | 1.2 | 12 | 418 | 382 | 9 |
| 32 | Y | 1.1 | 9 | 423 | 393 | 8 |

As shown in Table 6, the specimens 21, 22 and 23 exhibited a low strength since the Cu content (specimen 21), the Mg content (specimen 22), or the Si content (specimen 23) was less than the lower limit. The specimens 24, 25 and 26 produced cracks during extrusion since the Cu content (specimen 24), the Mg content (specimen 25), or the Si content (specimen 26) was more than the upper limit.

The specimens 27, 28, 29 and 30 formed a fiber structure and exhibited a low elongation due to the formation of giant constituent particles since the Mn content (specimen 27), the Cr content (specimen 28), the Zr content (specimen 29), or the V content (specimen 30) was more than the upper limit.

The specimens 31 and 32 exhibited a low elongation due to the formation of giant constituent particles since the content of Ti and B (specimen 31) or the Fe content (specimen 32) was more than the upper limit. The specimen 32 is considered to exhibit insufficient corrosion resistance since the Zn content was also more than the upper limit.

### Comparative Example 2

The ingot of each of the aluminum alloys A to M shown in Table 1 that were cast in Example 1 was homogenized, cooled, heated, and hot-extruded to have a cross-sectional shape having a width of 150 mm and a thickness of 0.7 mm (extrusion ratio: 299, billet diameter/minimum thickness ratio (D/T): 286). The extrusion speed (outlet-side product speed) was set at 5 m/min.

Each extruded product was subjected to a solution heat treatment, quenching, and artificial aging under the same conditions as in Example 1 to obtain specimens 33 to 45. The average aspect ratio and the orientation density of the grains of each specimen for which the normal to the {001} plane was parallel to the extrusion direction were measured under the same conditions as in Example 1. Each specimen was also subjected to a tensile test under the same conditions as in Example 1. The test results are shown in Table 7.

TABLE 7

| | | | Orientation density of | Tensile properties | | |
|---|---|---|---|---|---|---|
| | | Average | grains for which normal to | Ultimate | | |
| | | aspect ratio | {001} plane is parallel to | tensile strength | Proof stress | Elongation |
| Specimen | Alloy | of grains | extrusion direction | (MPa) | (MPa) | (%) |
| 33 | A | 1.4 | 69 | 350 | 319 | 14 |
| 34 | B | 1.5 | 69 | 297 | 265 | 17 |
| 35 | C | 1.5 | 71 | 260 | 234 | 19 |
| 36 | D | 1.3 | 67 | 383 | 371 | 13 |
| 37 | E | 1.3 | 68 | 432 | 401 | 12 |
| 38 | F | 1.4 | 68 | 330 | 277 | 15 |
| 39 | G | 1.5 | 69 | 390 | 389 | 13 |
| 40 | H | 2.3 | 80 | 361 | 311 | 14 |
| 41 | I | 2.5 | 85 | 359 | 309 | 15 |
| 42 | J | 2.4 | 84 | 363 | 320 | 14 |
| 43 | K | 2.1 | 79 | 371 | 315 | 14 |
| 44 | L | 2.0 | 76 | 357 | 305 | 15 |
| 45 | M | 1.6 | 71 | 340 | 317 | 15 |

As shown in Table 7, since the specimens 33 to 45 had a billet diameter/minimum thickness ratio (D/T) of 286 (>200), the orientation density of the grains for which the normal to the {001} plane was parallel to the extrusion direction in comparison with the grains orientated to random orientations was more than 50. As a result, specimens 33 to 45 exhibited a lower strength as compared with specimens 1 to 13 of Example 1.

### Comparative Example 3

The ingot of each of the aluminum alloys A to M shown in Table 1 that were cast in Example 1 was homogenized, cooled, heated, and hot-extruded to have a cross-sectional shape having a width of 150 mm and a thickness of 25 mm (extrusion ratio: 8.4, billet diameter/minimum thickness ratio (D/T): 8). The extrusion speed (outlet-side product speed) was set at 5 m/min.

Each extruded product was subjected to a solution treatment, quenching, and artificial aging under the same conditions as in Example 1 to obtain specimens 46 to 58. The average aspect ratio and the orientation density of the grains of each specimen for which the normal to the {001} plane was parallel to the extrusion direction were measured under the same conditions as in Example 1. Each specimen was also subjected to a tensile test under the same conditions as in Example 1. The test results are shown in Table 8.

TABLE 8

| | | | Orientation density of | Tensile properties | | |
|---|---|---|---|---|---|---|
| | | Average | grains for which normal to | Ultimate | | |
| | | aspect ratio | {001} plane is parallel to | tensile strength | Proof stress | Elongation |
| Specimen | Alloy | of grains | extrusion direction | (MPa) | (MPa) | (%) |
| 46 | A | 1.3 | 5 | 388 | 351 | 8 |
| 47 | B | 1.3 | 4 | 345 | 304 | 10 |
| 48 | C | 1.4 | 6 | 306 | 258 | 9 |
| 49 | D | 1.3 | 2 | 438 | 407 | 8 |
| 50 | E | 1.2 | 2 | 479 | 465 | 7 |
| 51 | F | 1.3 | 3 | 364 | 310 | 9 |
| 52 | G | 1.2 | 5 | 443 | 432 | 7 |
| 53 | H | 7.5 | 15 | 342 | 295 | 7 |
| 54 | I | 8.3 | 22 | 342 | 300 | 9 |
| 55 | J | 6.7 | 20 | 339 | 295 | 7 |
| 56 | K | 5.9 | 18 | 344 | 292 | 7 |
| 57 | L | 5.7 | 17 | 348 | 304 | 8 |
| 58 | M | 1.1 | 6 | 391 | 362 | 8 |

As shown in Table 8, the specimens 46 to 58 exhibited lower strength and lower elongation as compared with the specimens 1 to 13 of Example 1 since the extrusion ratio was 8.4 (<20). In particular, the specimens 53 to 57 showed a significant decrease in strength since the average aspect ratio of the grains was more than 5.0.

### Example 3

Each of the alloys (a to m) having the compositions shown in Table 9 were melted according to a conventional method to obtain a billet having a diameter of 155 mm. Each billet was homogenized at 540° C. for 10 hours, and subjected to porthole extrusion at a billet temperature of 500° C. and an extrusion speed of 6 m/min to obtain an extruded pipe material having an outer diameter of 15.0 mm and a thickness of 3.0 mm.

The extruded pipe material was subjected to a solution heat treatment at 540° C. for two hours, quenched into water at room temperature, drawn to an outer diameter of 13.0 mm and a thickness of 2.5 mm, and aged at 170° C. for seven hours.

The precipitates in the grains distribution condition and the average aspect ratio of the grains of the drawn product were measured, and the tensile properties of the drawn product was evaluated according to the following methods. The results are shown in Table 10.

Precipitates in the grains dispersion state: Thin film samples for TEM observation were formed from the specimen by electropolishing. A dark-field photograph (magnification: 100,000) of the precipitates was taken using a TEM from the (100) plane. The average length of the precipitates was calculated from the grains arranged in the [010] and [001] directions, and the number density of the precipitates was calculated from the grains arranged in the [100] direction. In order to reduce the statistical error, one specimen was photographed in three fields of view, and the average value was calculated and evaluated.

Average aspect ratio: A microstructure observation sample (10×10 mm) was cut from the specimen. The sample was fixed in a resin in order to observe the cross-section parallel to the extrusion direction. The sample was polished finally using #1200 emery paper, and etched at 25° C. for 20 seconds using a No. 3 etchant (2 ml of hydrofluoric acid, 3 ml of hydrochloric acid, 5 ml of nitric acid, and 190 ml of water) described in ASTM E407 to expose the grain structure. The sample was photographed using an optical microscope at a magnification of 50. The average size L of the grains of the specimen in the extrusion direction (lengthwise direction) and the average size ST of the specimen in the thickness direction were measured in accordance with ASTM E112. The average aspect ratio (L/ST) was then calculated. In order to reduce a statistical error, one specimen was photographed in three fields of view, and the average value was calculated and evaluated. Evaluation of tensile properties: A JIS No. 11 tensile test piece was formed using the specimen, and the ultimate tensile strength, the proof stress, and the elongation of the sample were measured in accordance with JIS Z 2241. The strength and the ductility of the sample were evaluated based on the measured values.

TABLE 9

| Al- | | | | | | | | | | | |
|---|---|---|---|---|---|---|---|---|---|---|---|
| loy | Si | Fe | Cu | Mn | Mg | Cr | Zn | Ti | Zr | V | B |
| a | 0.8 | 0.11 | 1.7 | 0.19 | 1.0 | 0.11 | 0.11 | 0.03 | 0.05 | 0.05 | 21 |
| b | 0.9 | 0.12 | 2.6 | 0.18 | 1.1 | 0.15 | 0.13 | 0.01 | 0.08 | 0.01 | 22 |
| c | 1.1 | 0.11 | 1.7 | 0.26 | 0.9 | 0.22 | 0.09 | 0.02 | 0.16 | 0.06 | 19 |
| d | 0.5 | 0.12 | 1.6 | 0.22 | 1.1 | 0.19 | 0.08 | 0.03 | 0.21 | 0.03 | 19 |
| e | 0.8 | 0.13 | 1.2 | 0.08 | 1.1 | 0.31 | 0.11 | 0.05 | 0.14 | 0.04 | 20 |
| f | 0.8 | 0.12 | 1.8 | 0.15 | 0.7 | 0.21 | 0.12 | 0.04 | 0.09 | 0.08 | 19 |
| g | 0.8 | 0.10 | 1.8 | 0.15 | 1.6 | 0.21 | 0.06 | 0.01 | 0.14 | 0.06 | 19 |
| h | 0.3 | 0.13 | 1.8 | 0.15 | 1.1 | 0.21 | 0.09 | 0.03 | 0.12 | 0.04 | 23 |
| i | 0.8 | 0.12 | 2.2 | 0.15 | 1.0 | 0.21 | 0.12 | 0.02 | 0.08 | 0.03 | 19 |
| j | 0.7 | 0.15 | 1.9 | 0.19 | 0.5 | 0.14 | 0.10 | 0.03 | 0.11 | 0.05 | 11 |
| k | 1.4 | 0.10 | 1.7 | 0.17 | 0.9 | 0.12 | 0.08 | 0.02 | 0.16 | 0.02 | 18 |
| l | 0.9 | 0.12 | 1.4 | 0.15 | 1.1 | 0.18 | 0.09 | 0.01 | 0.12 | 0.03 | 15 |
| m | 0.8 | 0.12 | 1.6 | 0.22 | 1.3 | 0.17 | 0.11 | 0.04 | 0.16 | 0.03 | 19 |

Unit: mass % (excluding B (ppm))

TABLE 10

| | | Precipitates in the grains | | | | Tensile properties | | |
|---|---|---|---|---|---|---|---|---|
| | | Average | Maximum length | Number density | Average aspect | Ultimate tensile | Proof stress | Elongation |
| Specimen | Alloy | length (nm) | (nm) | (/μm²) | ratio | strength (MPa) | (MPa) | (%) |
| 59 | a | 47 | 69 | 882 | 2.3 | 475 | 446 | 12 |
| 60 | b | 31 | 47 | 1524 | 2.4 | 527 | 494 | 9 |
| 61 | c | 43 | 68 | 986 | 2.2 | 492 | 473 | 11 |
| 62 | d | 54 | 80 | 737 | 2.0 | 455 | 417 | 12 |
| 63 | e | 56 | 86 | 692 | 2.4 | 468 | 446 | 12 |
| 64 | f | 51 | 79 | 784 | 2.0 | 460 | 425 | 11 |
| 65 | g | 36 | 54 | 1270 | 2.4 | 521 | 501 | 9 |
| 66 | h | 54 | 84 | 737 | 2.2 | 463 | 423 | 13 |
| 67 | i | 38 | 60 | 1152 | 2.3 | 493 | 459 | 10 |
| 68 | j | 56 | 82 | 692 | 2.2 | 459 | 420 | 11 |
| 69 | k | 38 | 57 | 1152 | 2.3 | 515 | 504 | 9 |
| 70 | l | 49 | 75 | 832 | 2.0 | 484 | 464 | 12 |
| 71 | m | 43 | 64 | 986 | 2.4 | 504 | 481 | 11 |

As shown in Table 10, the specimens 59 to 71 according to the present invention had a precipitates in the grains distribution condition and an average aspect ratio within the specified ranges, and exhibited excellent tensile properties.

### Example 4

A billet (diameter: 155 mm) of the alloy “a” shown in Table 9 was homogenized in the same manner as in Example 3, and subjected to porthole extrusion at a billet temperature of 500° C. and an extrusion speed of 6 m/min to obtain an extruded pipe material. The extruded pipe material was subjected to a solution heat treatment in the same manner as in Example 3, drawn into the shape of pipe that differed in diameter, and then artificially aged. The specimen 77 was drawn at a rate of reduction in cross-sectional area of 9% after extrusion, subjected to a solution heat treatment, further drawn, and then artificially aged. The specimen 78 was press-quenched. Table 11 shows the production conditions of the specimen.

The transgranular precipitate distribution condition and the average aspect ratio of the grains of the drawn product were measured, and the tensile properties of the drawn product were evaluated in the same manner as in Example 3. The results are shown in Table 12.

TABLE 11

| | Homogenization | | | | Solution treatment | |
|---|---|---|---|---|---|---|
| | condition | | Extrusion condition | | condition | |
| Specimen | Temp. (° C.) | Time (h) | Billet temperature (° C.) | Extrusion speed (m/min) | Temp. (° C.) | Time (h) |
| 72 | 500 | 8 | 500 | 6 | 540 | 2 |
| 73 | 520 | 8 | 500 | 6 | 540 | 2 |
| 74 | 540 | 8 | 500 | 6 | 540 | 2 |
| 75 | 520 | 8 | 500 | 6 | 525 | 2 |
| 76 | 520 | 8 | 500 | 6 | 545 | 2 |
| 77 | 520 | 8 | 500 | 6 | 540 | 2 |
| 78 | 520 | 8 | 500 | 6 | Press quenching | |
| 79 | 520 | 8 | 500 | 6 | 540 | 2 |
| 80 | 520 | 8 | 500 | 6 | 540 | 2 |
| 81 | 520 | 8 | 500 | 6 | 540 | 2 |
| 82 | 520 | 8 | 500 | 6 | 540 | 2 |
| 83 | 520 | 8 | 500 | 6 | 540 | 2 |
| 84 | 520 | 8 | 500 | 6 | 540 | 2 |

| | Drawing condition after solution heat treatment | | | | | | | | |
|---|---|---|---|---|---|---|---|---|---|
| | | | | | Rate of | Rate of | | | |
| | Dimensions before | | Dimensions after | | reduction | reduction | | | |
| | drawing | | drawing | | in | in | | | |
| | Outer | | Outer | | outer | cross- | Aging condition | | |
| | diameter | Thickness | diameter | Thickness | diameter | sectional | Temp. | Time | (ε/100) × |
| Specimen | (mm) | (mm) | (mm) | (mm) | (%) | area (%) | (° C.) | (h) | (T − 120) × t |
| 72 | 15.0 | 3.0 | 13.0 | 2.5 | 13.3 | 27.1 | 170 | 7 | 95 |
| 73 | 15.0 | 3.0 | 13.0 | 2.5 | 13.3 | 27.1 | 170 | 7 | 95 |
| 74 | 15.0 | 3.0 | 13.0 | 2.5 | 13.3 | 27.1 | 170 | 7 | 95 |
| 75 | 15.0 | 3.0 | 13.0 | 2.5 | 13.3 | 27.1 | 170 | 7 | 95 |
| 76 | 15.0 | 3.0 | 13.0 | 2.5 | 13.3 | 27.1 | 170 | 7 | 95 |
| 77 | 14.5 | 2.8 | 13.0 | 2.5 | 10.3 | 19.9 | 170 | 7 | 70 |
| 78 | 15.0 | 3.0 | 13.0 | 2.5 | 13.3 | 27.1 | 170 | 7 | 95 |
| 79 | 15.0 | 3.0 | 13.5 | 2.5 | 10.0 | 23.6 | 170 | 7 | 83 |
| 80 | 15.0 | 3.0 | 12.0 | 2.5 | 20.0 | 34.0 | 170 | 7 | 119 |
| 81 | 15.0 | 3.0 | 11.0 | 2.5 | 26.7 | 41.0 | 170 | 7 | 143 |
| 82 | 15.0 | 3.0 | 13.0 | 2.5 | 13.3 | 27.1 | 150 | 7 | 57 |
| 83 | 15.0 | 3.0 | 13.0 | 2.5 | 13.3 | 27.1 | 170 | 7 | 95 |
| 84 | 15.0 | 3.0 | 13.0 | 2.5 | 13.3 | 27.1 | 190 | 7 | 133 |

TABLE 12

| | | Precipitates in the grains | | | | Tensile properties | | |
|---|---|---|---|---|---|---|---|---|
| | | Average | Maximum | Number | Average | Ultimate | Proof | |
| | | length | length | density | aspect | tensile | stress | Elongation |
| Specimen | Alloy | (nm) | (nm) | (/μm²) | ratio | strength (MPa) | (MPa) | (%) |
| 772 | a | 48 | 69 | 783 | 2.1 | 475 | 453 | 12 |
| 73 | a | 43 | 64 | 960 | 2.0 | 486 | 460 | 12 |
| 74 | a | 43 | 63 | 1135 | 2.3 | 507 | 475 | 11 |
| 75 | a | 45 | 70 | 708 | 2.4 | 458 | 431 | 13 |
| 76 | a | 29 | 43 | 1435 | 2.5 | 512 | 488 | 11 |
| 77 | a | 34 | 52 | 1233 | 2.3 | 501 | 474 | 11 |
| 78 | a | 62 | 89 | 670 | 2.2 | 467 | 442 | 13 |
| 79 | a | 49 | 75 | 850 | 2.4 | 479 | 459 | 12 |
| 80 | a | 35 | 55 | 1181 | 2.3 | 500 | 468 | 11 |
| 81 | a | 26 | 40 | 1563 | 2.4 | 521 | 499 | 10 |
| 82 | a | 35 | 55 | 887 | 2.0 | 467 | 442 | 13 |
| 83 | a | 46 | 65 | 905 | 2.3 | 483 | 462 | 12 |
| 84 | a | 55 | 80 | 1065 | 2.4 | 516 | 496 | 11 |

As shown in Table 12, the specimens 72 to 84 according to the present invention had a precipitates in the grains distribution condition and an average aspect ratio within the specified ranges, and exhibited excellent tensile properties.

### Comparative Example 4

A drawn product was produced in the same manner as in Example 3 using each of alloys n to z having compositions shown in Table 13. The precipitates in the grains dispersion state and the average aspect ratio of the grains of the drawn product were measured, and the tensile properties of the drawn product were evaluated in the same manner as in Example 3. The results are shown in Table 14.

TABLE 13

| Alloy | Si | Fe | Cu | Mn | Mg | Cr | Zn | Ti | Zr | V | B |
|---|---|---|---|---|---|---|---|---|---|---|---|
| n | 0.7 | 0.13 | 0.9 | 0.09 | 0.9 | 0.15 | 0.06 | 0.01 | 0.18 | 0.05 | 18 |
| o | 0.8 | 0.14 | 3.2 | 0.18 | 1.0 | 0.18 | 0.14 | 0.03 | 0.11 | 0.03 | 19 |
| p | 0.7 | 0.12 | 1.8 | 0.20 | 0.3 | 0.30 | 0.22 | 0.05 | 0.05 | 0.04 | 19 |
| q | 0.8 | 0.13 | 1.7 | 0.21 | 2.0 | 0.22 | 0.16 | 0.05 | 0.08 | 0.06 | 19 |
| r | 0.1 | 0.12 | 1.8 | 0.16 | 1.0 | 0.13 | 0.27 | 0.03 | 0.13 | 0.03 | 11 |
| s | 1.7 | 0.11 | 1.9 | 0.19 | 1.1 | 0.17 | 0.26 | 0.04 | 0.16 | 0.01 | 19 |
| t | 0.8 | 0.10 | 1.7 | 0.36 | 1.0 | 0.19 | 0.22 | 0.05 | 0.09 | 0.05 | 10 |
| u | 0.9 | 0.10 | 1.8 | 0.15 | 0.9 | 0.44 | 0.18 | 0.03 | 0.14 | 0.04 | 12 |
| v | 0.9 | 0.12 | 1.8 | 0.13 | 1.0 | 0.21 | 0.15 | 0.01 | 0.30 | 0.03 | 22 |
| w | 0.8 | 0.13 | 1.6 | 0.19 | 1.0 | 0.15 | 0.24 | 0.04 | 0.13 | 0.16 | 22 |
| x | 0.8 | 0.11 | 1.7 | 0.09 | 1.1 | 0.10 | 0.19 | 0.25 | 0.18 | 0.04 | 8.5 |
| y | 0.9 | 0.51 | 1.8 | 0.22 | 1.0 | 0.16 | 0.13 | 0.03 | 0.17 | 0.02 | 20 |
| z | 0.7 | 0.13 | 1.8 | 0.21 | 1.0 | 0.18 | 0.43 | 0.04 | 0.08 | 0.05 | 18 |

Unit: mass % (excluding B (ppm))

TABLE 14

| | | Precipitates in the grains | | | | Tensile properties | | |
|---|---|---|---|---|---|---|---|---|
| | | Average | Maximum length | Number density | Average aspect | Ultimate tensile | Proof stress | Elongation |
| Specimen | Alloy | length (nm) | (nm) | (/um²) | ratio | strength (MPa) | (MPa) | (%) |
| 85 | n | 54 | 81 | 415 | 2.3 | 416 | 388 | 13 |
| 86 | o | 27 | 42 | 1800 | 2.3 | 504 | 483 | 6 |
| 87 | p | 48 | 74 | 381 | 2.5 | 376 | 336 | 11 |
| 88 | q | 32 | 48 | 1458 | 2.3 | 521 | 501 | 6 |
| 89 | r | 50 | 76 | 450 | 2.1 | 400 | 347 | 12 |
| 90 | s | 30 | 46 | 1590 | 2.4 | 525 | 509 | 5 |
| 91 | t | Clogging occurred | | | | | | |
| 92 | u | Clogging occurred | | | | | | |
| 93 | v | Clogging occurred | | | | | | |
| 94 | w | Clogging occurred | | | | | | |
| 95 | x | 45 | 65 | 933 | 2.2 | 486 | 459 | 4 |
| 96 | y | 43 | 64 | 986 | 2.0 | 488 | 462 | 5 |
| 97 | z | 48 | 72 | 857 | 2.4 | 467 | 435 | 5 |

As shown in Table 14, the specimens 85, 87, and 89 had an insufficient precipitates in the grains number density since the content of Cu, Mg, and Si was lower than the lower limit, respectively. As a result, the specimens 85, 87, and 89 exhibited insufficient strength. The specimens 86, 88, and 90 exhibited a low ductility since the content of Cu, Mg, and Si was higher than the upper limit, respectively. The specimens 91, 92, 93, and 94 had a high deformation resistance since the content of Mn, Cr, Zr, and V was higher than the upper limit, respectively. As a result, clogging occurred during extrusion so that a sample could not be obtained. The specimen 95 exhibited a low ductility since the content of Ti and B was higher than the upper limit. The specimen 96 exhibited a low ductility since the Fe content was higher than the upper limit. The specimen 97 exhibited a low ductility since the Zn content was higher than the upper limit.

### Comparative Example 5

A billet (diameter: 155 mm) of the alloy “a” shown in Table 9 was homogenized, and then subjected to porthole extrusion to obtain an extruded pipe material. The extruded pipe material was subjected to a solution heat treatment, quenched into water at room temperature, drawn into a pipe shape having a different diameter, and then artificially aged to obtain a drawn product (specimen). Table 15 shows the specimen producing conditions.

The transgranular precipitate distribution condition and the average aspect ratio of the grains of the specimen were measured, and the tensile properties of the specimen were evaluated in the same manner as in Example 3. The results are shown in Table 16. Note that the specimen 107 was air-cooled using a fan at a cooling rate of 50° C./min after the solution heat treatment.

TABLE 15

| | | | | | Solution | |
|---|---|---|---|---|---|---|
| | Homogenization | | | | treatment | |
| | condition | | Extrusion condition | | condition | |
| Specimen | Temp. (° C.) | Time (h) | Billet temperature (° C.) | Extrusion speed (m/min) | Temp. (° C.) | Time (h) |
| 98 | 450 | 8 | 500 | 6 | 540 | 2 |
| 99 | 570 | 8 | 500 | 6 | 540 | 2 |
| 100 | 520 | 1 | 500 | 6 | 540 | 2 |
| 101 | 520 | 8 | 420 | 6 | 540 | 2 |
| 102 | 520 | 8 | 540 | 6 | 540 | 2 |
| 103 | 520 | 8 | 500 | 20 | 540 | 2 |
| 104 | 520 | 8 | 500 | 6 | 500 | 2 |
| 105 | 520 | 8 | 500 | 6 | 570 | 2 |
| 106 | 520 | 8 | 500 | 6 | 540 | 0.5 |
| 107 | 520 | 8 | 500 | 6 | 540 | 2 |
| 108 | 520 | 8 | 500 | 6 | 540 | 2 |
| 109 | 520 | 8 | 500 | 6 | 540 | 2 |
| 110 | 520 | 8 | 500 | 6 | 540 | 2 |
| 111 | 520 | 8 | 500 | 6 | 540 | 2 |
| 112 | 520 | 8 | 500 | 6 | 540 | 2 |
| 113 | 520 | 8 | 500 | 6 | 540 | 2 |
| 114 | 520 | 8 | 500 | 6 | 540 | 2 |

| | Drawing condition after solution heat treatment | | | | | | | | |
|---|---|---|---|---|---|---|---|---|---|
| | Dimensions | | Dimensions | | Rate of | Rate of | | | |
| | before drawing | | after drawing | | reduction | reduction | | | |
| | Outer | | Outer | | in outer | in cross- | Aging condition | | |
| | diameter | Thickness | diameter | Thickness | diameter | sectional | Temp. | Time | (ε/100) × |
| Specimen | (mm) | (mm) | (mm) | (mm) | (%) | area (%) | (° C.) | (h) | (T − 120) × t |
| 98 | 15.0 | 3.0 | 13.0 | 2.5 | 13.3 | 27.1 | 170 | 7 | 95 |
| 99 | 15.0 | 3.0 | 13.0 | 2.5 | 13.3 | 27.1 | 170 | 7 | 95 |
| 100 | 15.0 | 3.0 | 13.0 | 2.5 | 13.3 | 27.1 | 170 | 7 | 95 |
| 101 | 15.0 | 3.0 | 13.0 | 2.5 | 13.3 | 27.1 | 170 | 7 | 95 |
| 102 | 15.0 | 3.0 | 13.0 | 2.5 | 13.3 | 27.1 | 170 | 7 | 95 |
| 103 | 15.0 | 3.0 | 13.0 | 2.5 | 13.3 | 27.1 | 170 | 7 | 95 |
| 104 | 15.0 | 3.0 | 13.0 | 2.5 | 13.3 | 27.1 | 170 | 7 | 95 |
| 105 | 15.0 | 3.0 | 13.0 | 2.5 | 13.3 | 27.1 | 170 | 7 | 95 |
| 106 | 15.0 | 3.0 | 13.0 | 2.5 | 13.3 | 27.1 | 170 | 7 | 95 |
| 107 | 15.0 | 3.0 | 13.0 | 2.5 | 13.3 | 27.1 | 170 | 7 | 95 |
| 108 | 15.0 | 3.0 | 14.2 | 2.9 | 5.3 | 9.0 | 170 | 7 | 31 |
| 109 | 15.0 | 3.0 | 9.5 | 2.2 | 36.7 | 55.4 | 170 | 7 | 194 |
| 110 | 15.0 | 3.0 | 14.5 | 2.0 | 3.3 | 30.6 | 170 | 7 | 107 |
| 111 | 15.0 | 3.0 | 13.0 | 2.5 | 13.3 | 27.1 | 125 | 7 | 9 |
| 112 | 15.0 | 3.0 | 13.0 | 2.5 | 13.3 | 27.1 | 240 | 7 | 228 |
| 113 | 15.0 | 3.0 | 13.0 | 2.5 | 13.3 | 27.1 | 170 | 1 | 14 |
| 114 | 15.0 | 3.0 | 13.0 | 2.5 | 13.3 | 27.1 | 170 | 30 | 406 |

TABLE 16

| | | Precipitates in the grains | | | | Tensile properties | | |
|---|---|---|---|---|---|---|---|---|
| | | Average | Maximum | Number | Average | Ultimate | Proof | |
| | | length | length | density | aspect | tensile strength | stress | Elongation |
| Specimen | Alloy | (nm) | (nm) | (W) | ratio | (MPa) | (MPa) | (%) |
| 98 | a | 51 | 77 | 467 | 2.4 | 421 | 394 | 14 |
| 99 | a | 40 | 61 | 1351 | 2.0 | 440 | 418 | 6 |
| 100 | a | 62 | 95 | 486 | 2.2 | 430 | 401 | 13 |
| 101 | a | 50 | 81 | 905 | 4.5 | 438 | 406 | 10 |
| 102 | a | Cracking occurred during extrusion | | | | | | |
| 103 | a | Clogging occurred | | | | | | |
| 104 | a | 53 | 76 | 430 | 2.0 | 416 | 381 | 15 |
| 105 | a | 26 | 41 | 1564 | 2.5 | 421 | 391 | 3 |
| 106 | a | 46 | 71 | 445 | 2.2 | 422 | 385 | 14 |
| 107 | a | 38 | 59 | 360 | 2.2 | 411 | 343 | 15 |
| 108 | a | 86 | 130 | 550 | 1.7 | 410 | 387 | 13 |
| 109 | a | Cracking occurred during drawing | | | | | | |
| 110 | a | 90 | 138 | 513 | 2.3 | 400 | 376 | 14 |
| 111 | a | 8 | 24 | 1403 | 2.4 | 394 | 353 | 15 |
| 112 | a | 133 | 191 | 121 | 2.0 | 346 | 303 | 17 |
| 113 | a | 6 | 15 | 859 | 1.9 | 409 | 381 | 15 |
| 114 | a | 122 | 190 | 339 | 2.3 | 439 | 416 | 14 |

As shown in Table 16, since the specimens 98 and 100 were insufficiently homogenized, the number density of the precipitates decreased so that the strength decreased. Since the specimen 99 underwent eutectic melting due to a high homogenization temperature, the strength and the elongation decreased. Since the specimen 101 was extruded at a low temperature, fibrous grains non-uniformly remained in the extruded product. As a result, the strength decreased due to an increase in average aspect ratio. Since the specimen 102 was extruded at a high temperature, eutectic melting occurred due to heat generated during working so that cracks occurred in the extruded product. Since the specimen 103 had a high deformation resistance, clogging occurred during extrusion so that a sample could not be obtained.

Since the solution heat treatment of the specimens 104 and 106 was insufficient, the number density of the precipitates decreased so that the strength decreased. Since the specimen 105 underwent eutectic melting due to a high solution heat treatment temperature, the strength and the elongation decreased. Since the specimen 107 was cooled at a low cooling rate after the solution heat treatment, the solute main elements content decreased. As a result, the number of precipitates precipitated during artificial aging decreased so that the strength decreased. Since the specimen 108 was drawn at a low reduction ratio, the average length and the maximum length of the precipitates exceeded the upper limit so that the strength decreased. Since the drawing reduction ratio of the specimen 109 was higher than the upper limit of the deformability of the alloy, the material broke during drawing.

Since the rate of reduction in outer diameter of the specimen 110 was low, the average length and the maximum length of the precipitates exceeded the upper limit so that the strength decreased. Since the specimen 111 was aged at a low temperature, the average length of the precipitates was less than the lower limit so that the strength decreased. Since the specimen 112 was aged at a high temperature, the size of the precipitates increased so that the strength decreased. Since the specimen 113 was aged for a short period of time, the average length of the precipitates was less than the lower limit so that the strength decreased. Since the specimen 114 was aged for a long period of time, the size of the precipitates increased so that the strength decreased.

### INDUSTRIAL APPLICABILITY

Since the heat-treated high-strength Al—Cu—Mg—Si aluminum alloy extruded product according to the first embodiment exhibits excellent extrudability and high strength, the aluminum alloy extruded product can be suitably used as a transport structural material (e.g., aircraft structural material). Since the heat-treated high-strength Al—Cu—Mg—Si cold-worked aluminum alloy product according to the second embodiment exhibits an excellent extrudability, allows the production of a hollow extruded product by porthole extrusion, and exhibits a high strength, the aluminum alloy product can produce a cold-worked pipe product that can be suitably used as a transport material (e.g., motorcycle structural material).

What is claimed is:

1. A high-strength Al—Cu—Mg—Si aluminum alloy product obtained by extrusion and cold working, rod-shaped precipitates being arranged in the grains of the matrix in the <100> direction, the precipitates having an average length of 10 to 70 nm and a maximum length of 120 nm or less, and the number density of the precipitates in the [001] direction measured from the (001) plane being 500 or more per square micrometer.

2. The aluminum alloy product according to claim 1, comprising 1.0 to 3.0% of Cu, 0.4 to 1.8% of Mg, and 0.2 to 1.6% of Si, with the balance being Al and unavoidable impurities.

3. The aluminum alloy product according to claim 2, further comprising at least one of 0.30% or less of Mn, 0.40% or less of Cr, 0.25% or less of Zr, and 0.10% or less of V.

4. The aluminum alloy product according to claim 2, further comprising at least one of 0.15% or less of Ti and 50 ppm or less of B.

5. The aluminum alloy product according to claim 1, wherein the matrix has a structure formed of equiaxial recrystallized grains, and has an average aspect ratio (L/ST) of the average size L of the grains in the extrusion direction to the average size ST of the grains in the thickness direction of 1.5 to 4.0.

6. The aluminum alloy product according to claim 1, the aluminum alloy product having an ultimate tensile strength of 450 MPa or more, a proof stress of 400 MPa or more and an elongation of 7% or more.
